(19) United States
(12) Patent Application Publication
(10) Pub. No.: US 2019/0244778 A1
(43) Pub. Date: Aug. 8, 2019

(54) CONDUCTOR SEVERING CIRCUIT BREAKER

(71) Applicant: GE Aviation Systems LLC, Grand Rapids, MI (US)

(72) Inventors: Nader Dariavach, Lake Worth, FL (US); Kenneth Howard Schnorr, Palm Beach Gardens, FL (US)

(21) Appl. No.: 15/888,753

(22) Filed: Feb. 5, 2018

(51) Int. Cl. H01H 39/00; H02H 3/20; H02H 3/08; H02H 3/02

(52) U.S. Cl. CPC H01H 39/006; H02H 3/021; H02H 3/08; H02H 3/20

(57) ABSTRACT

A circuit breaker or conductor severing assembly can include a housing with a conductor extending through the housing. A piston disposed within the interior of the housing can be actuable within the housing between a first position and a second position, driven by a volume expansion composition. The piston can include a cutter, such that actuation to the second position can sever the conductor extending through the housing.

### BACKGROUND OF THE INVENTION

A circuit breaker is an electrical element adapted to protect an electrical circuit from damage by breaking an electrical connection, typically due to an overload or a short circuit. The electrical element can be in the form of a melting fuse forming a portion of the circuit. The fuse can have a low melting point, which can melt from ohmic heating when the circuit is operating at a heightened current. In one non-limiting example, the fuse can be a sacrificial device, which needs replacement once operation has occurred.

Melting fuses include disadvantages, such as edging, uncertainty, and variable calibration. Edging is the deterioration of the fuse over time, such as through oxidation or through the continuous heating and cooling of the element during usage of the circuit. Edging can lead to unreliability of the circuit breaker or unintended breaking of the circuit. Furthermore, edging reduces the current rating of the fuse over time. Such deterioration also leads to uncertainty or unpredictability of fuse function or operations over time, as ambient conditions can impact the reliability of the circuit breaker as lifetime of the circuit increases. Finally, accurate calibration of the fuse is difficult or impossible as the fusing current is dependent on the length of the fusing element.

Additionally, fuses typically have a delay before operating and breaking the circuit. A delay example can be 0.2 seconds or more. The delay is the result of heating of the fuse to a melting temperature and the melting of the fuse to break the circuit. A delay can result in damage to the circuit, or sparking in the interim.

Additional circuit breakers can include an electro-magnetic circuit breaker or solenoid circuit breakers, for example, which use magnetic forces to break the circuit. However, the electromagnetic circuit breakers are large, occupying a large space on the typical circuit. Additionally, electromagnetic circuit breakers have an increased cost as compared to fuse-type circuit breakers. Additionally, the electromagnetic circuit breakers have a delay of at least 0.2 seconds.

### BRIEF DESCRIPTION OF THE INVENTION

In one aspect, the disclosure relates to a conductor severing assembly including a housing having an inner surface defining cavity. A conductor extends through the housing. A piston is disposed within the cavity and includes an upper surface contoured to match at least a portion of the inner surface of the housing. The piston is linearly moveable between a first position and a second position. An actuator is disposed within the sealed cavity. Expansion of the actuator operably drives the piston from the first position to the second position, wherein the second position severs the conductor.

In another aspect, the disclosure relates to a circuit breaker device including a housing defining a volume expansion chamber, with the volume expansion chamber defined by at least one side wall and a top wall. A conductor extends through the housing and electrically connecting an input with an output and at least partially defining a circuit. A cutter is disposed within the housing and includes a first blade end and an opposing second end. The second end is contoured to correspond with the at least one side wall of the volume expansion chamber. A volume expansion composition is disposed within the volume expansion chamber between the top wall and the second end of the cutter, with the volume expansion composition adapted to volumetrically expand in response to a trigger signal. A controller module is configured to sense an electrical characteristic of the circuit, and in response to determining the electrical characteristic of the circuit satisfies a threshold electrical characteristic, generating the trigger signal. Whereby the volumetric expansion of the volume expansion composition within the volume expansion chamber against the second end of the cutter operably forces the first blade end of the cutter through the conductor such that the first blade end electrically disconnects the input from the output.

In yet another aspect, the disclosure relates to a method of breaking a circuit having a conductor severing assembly including a housing with a cutter drivable by a volume expansion composition and a conductor passing through the housing forming a portion of the circuit, the method including: sensing an electrical characteristic of the circuit with a controller module; comparing the sensed electrical characteristic with a threshold characteristic; and generating a trigger signal with the controller module when the sensed electrical characteristic meets the threshold characteristic, wherein the trigger signal triggers the volumetric expansion composition to drive the cutter through the conductor to sever the conductor passing through the housing.

### BRIEF DESCRIPTION OF THE DRAWINGS

In the drawings:

FIG. 1 is a schematic view an electrical circuit including a conductor severing assembly, in accordance with aspects described herein.

FIG. 2 is a schematic view of the electrical circuit of FIG. 1 including the conductor severing assembly utilizing a controller module coupled to a solid state power controller and the conductor severing assembly, in accordance with aspects described herein.

FIG. 3 is a cross-sectional view of the conductor severing assembly of FIG. 2 including a piston and a volume expansion composition, with the piston in a first position, in accordance with aspects described herein.

FIG. 4 is a cross-sectional view of the conductor severing assembly of FIG. 3 illustrating expansion of the volume expansion composition, driving the piston into a second position, in accordance with aspects described herein.

FIG. 5 is a cross-sectional view of another conductor severing assembly of FIG. 1, illustrating a piston provided in a first position, in accordance with aspects described herein.

FIG. 6 is a cross-sectional view of the conductor severing assembly of FIG. 5 illustrating the piston into a second position, in accordance with aspects described herein.

FIG. 7 is a block diagram illustrating a method of breaking a circuit with a conductor severing assembly of FIG. 1, in accordance with aspects described herein.

### DESCRIPTION OF EMBODIMENTS OF THE INVENTION

The disclosure is related to a mechanical-type circuit breaker, having a cutting-type actuator or piston mechanism that is configured, adapted, or otherwise operable to sever a conductor to break an electrical connection in a circuit. The actuator or piston is actuated by a volume expansion of an actuator or volume expansion composition adapted to drive the actuator or piston. While described herein as a chemical reaction or an explosive reaction, it should be understood that any volume expansion or operation to drive the actuator or piston is contemplated. The disclosure can be applicable to circuit breakers in high or low voltage alternating current (AC) or direct current (DC) circuits. The circuit breaker as described herein provides for faster breaking of the circuit, which can reduce damage to the circuit resultant of an event triggering breaking of the circuit, such as a voltage overload. Additionally, the circuit breaker provides for an improved reliability as compared to current circuit breakers, such as those using fuse-type breakers.

A volume expansion composition as used herein can be any suitable thing, element, matter, compound, material, or composition that is configured to expand in volume. Expansion of the volume expansion composition can be triggered by any suitable means, such as ignition, supply of electrical current, heat, or even providing additional gas or fluid to expand the volume expansion composition.

As used herein, the term “forward” or “upstream” refers to moving in a direction toward the engine inlet, or a component being relatively closer to the engine inlet as compared to another component. The term “aft” or “downstream” used in conjunction with “forward” or “upstream” refers to a direction toward the rear or outlet of the engine or being relatively closer to the engine outlet as compared to another component. Additionally, as used herein, the terms “radial” or “radially” refer to a dimension extending between a center longitudinal axis of the engine and an outer engine circumference. Furthermore, as used herein, the term “set” or a “set” of elements can be any number of elements, including only one.

All directional references (e.g., radial, axial, proximal, distal, upper, lower, upward, downward, left, right, lateral, front, back, top, bottom, above, below, vertical, horizontal, clockwise, counterclockwise, upstream, downstream, forward, aft, etc.) are only used for identification purposes to aid the reader's understanding of the present disclosure, and do not create limitations, particularly as to the position, orientation, or use of aspects of the disclosure described herein. Connection references (e.g., attached, coupled, connected, and joined) are to be construed broadly and can include intermediate members between a collection of elements and relative movement between elements unless otherwise indicated. As such, connection references do not necessarily infer that two elements are directly connected and in fixed relation to one another. The exemplary drawings are for purposes of illustration only and the dimensions, positions, order and relative sizes reflected in the drawings attached hereto can vary.

Also as used herein, while sensors can be described as “sensing” or “measuring” a respective value, sensing or measuring can include determining a value indicative of or related to the respective value, rather than directly sensing or measuring the value itself. The sensed or measured values can further be provided to additional components. For instance, the value can be provided to a controller module or processor, and the controller module or processor can perform processing on the value to determine a representative value or an electrical characteristic representative of said value.

Additionally, while terms such as “voltage”, “current”, and “power” can be used herein, it will be evident to one skilled in the art that these terms can be interchangeable when describing aspects of the electrical circuit, or circuit operations.

As used herein, a “system” or a “controller module” can include at least one processor and memory. Non-limiting examples of the memory can include Random Access Memory (RAM), Read-Only Memory (ROM), flash memory, or one or more different types of portable electronic memory, such as discs, DVDs, CD-ROMs, etc., or any suitable combination of these types of memory. The processor can be configured to run any suitable programs or executable instructions designed to carry out various methods, functionality, processing tasks, calculations, or the like, to enable or achieve the technical operations or operations described herein. The program can include a computer program product that can include machine-readable media for carrying or having machine-executable instructions or data structures stored thereon. Such machine-readable media can be any available media, which can be accessed by a general purpose or special purpose computer or other machine with a processor. Generally, such a computer program can include routines, programs, objects, components, data structures, algorithms, etc., that have the technical effect of performing particular tasks or implement particular abstract data types.

As used herein, a controllable switching element, or a “switch” is an electrical device that can be controllable to toggle between a first mode of operation, wherein the switch is “closed” intending to transmit current from a switch input to a switch output, and a second mode of operation, wherein the switch is “open” intending to prevent current from transmitting between the switch input and switch output. In non-limiting examples, connections or disconnections, such as connections enabled or disabled by the controllable switching element, can be selectively configured to provide, enable, disable, or the like, an electrical connection between respective elements.

The disclosure can be implemented in any electrical circuit environment having a switch. A non-limiting example of an electrical circuit environment that can include aspects of the disclosure can include an aircraft power system architecture, which enables production of electrical power from at least one spool of a turbine engine, preferably a gas turbine engine, and delivers the electrical power to a set of electrical loads via at least one solid state switch, such as a solid state power controller (SSPC) switching device. One non-limiting example of the SSPC can include a silicon carbide (SiC) or Gallium Nitride (GaN) based, high power switch. SiC or GaN can be selected based on their solid state material construction, their ability to handle high voltages and large power levels in smaller and lighter form factors, and their high speed switching ability to perform electrical operations very quickly. Additional switching devices or additional silicon-based power switches can be included.

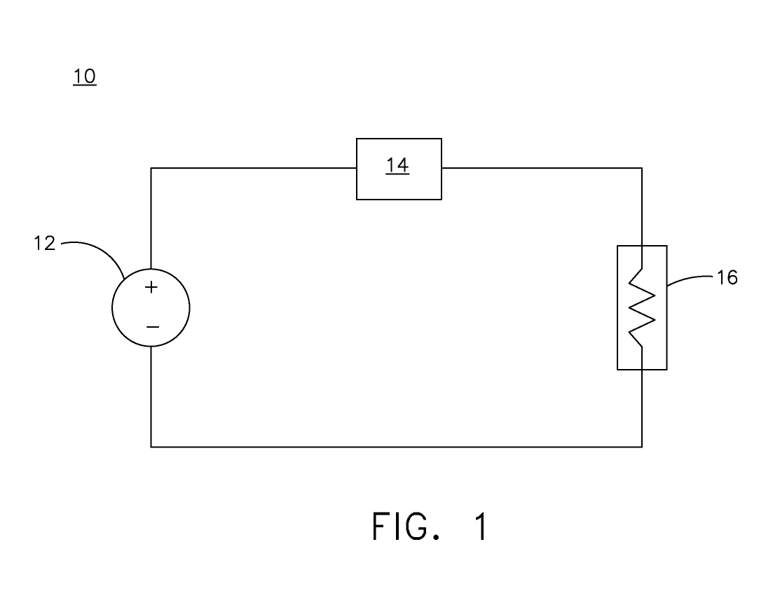

Referring to FIG. 1, an electrical circuit 10 includes a power source, such as a voltage source 12, a conductor severing assembly illustrated as a circuit breaker 14, and an electrical load 16 schematically shown as a resistor. In one example, the circuit 10 can be formed on a printed circuit board (PCB) as a circuit board assembly component and the elements as shown can be the components of a circuit board. It should be understood that the electric circuit 10 is merely one representative electrical circuit for ease of understanding, and aspects of the disclosure can be applied to any basic or complex electrical circuits, PCB, or the like. The voltage source 12 can be any suitable voltage source for supplying electrical power to the electrical circuit 10 or the electrical load 16. In one example, the voltage source 12 can be an ideal two-terminal device that maintains a fixed voltage drop. The voltage source 12 drives the electrical load 16 defining a current for the circuit 10. The circuit breaker 14 can be a circuit breaker, such as the conductor severing assembly, adapted to mechanically break the electrical circuit 10. For example, it may be desirable to break the electrical circuit in order to prevent damage to the circuit due to overload or a short circuit.

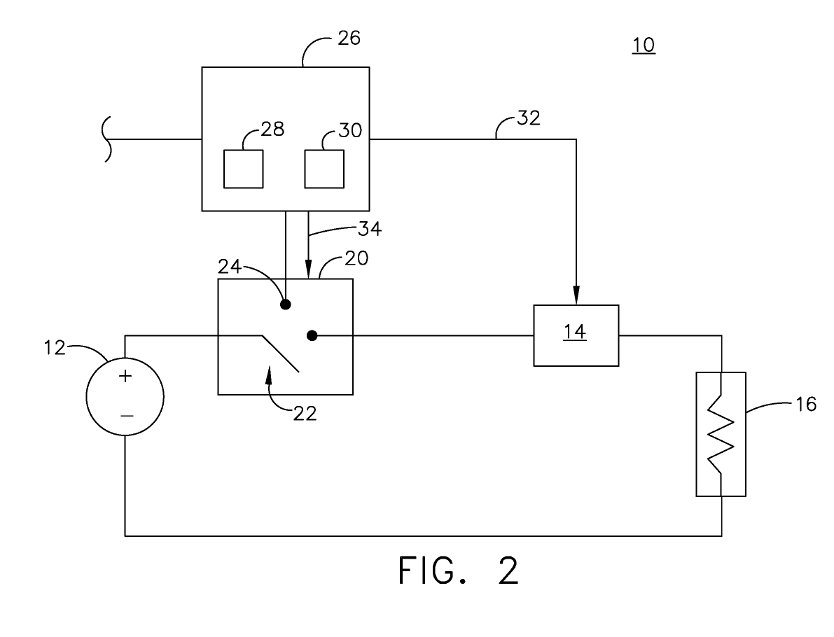

Referring now to FIG. 2, the electronic circuit 10 can further include a semiconductor switch illustrated as a solid state power controller (SSPC) 20 or any other suitable switch. In one non-limiting example, the SSPC 20 can be a metal-oxide-semiconductor field-effect transistor (MOSFET), but is schematically illustrated as a switchable element 22, for ease of understanding. As such, the switchable element 22 can enable or operate to either connect or disconnect the power source 12 with the downstream circuit breaker 14 and electrical load 16. The SSPC 20 can further include an electrical characteristic sensor 24, such as a current sensor, a voltage sensor, or a power sensor, configured or adapted to sense a corresponding electrical characteristic at the SSPC 20.

The electronic circuit 10 can further include a controller module 26 having a processor 28 and a memory 30. The controller module 26 can be communicatively connected with the electrical characteristic sensor 24, such that the controller module 26 can receive the sensed electrical characteristic at the SSPC 20. The controller module 26 can also be communicatively or operably connected with the circuit breaker 14, for example, by way of a trigger signal pathway 32. Non-limiting aspects of the disclosure can be included wherein the controller module 26 can also be adapted, configured, or the like to controllably operate the switchable element 22 by way of a control signal, schematically illustrated as arrow 34.

The controller module 26 can be configured to receive the sensed electrical characteristic measured at the electrical characteristic sensor 24. The electrical characteristic, for example, can be a voltage value or range, a current value or range, or a power value or range, at the SSPC 20. The controller module 26 can further compare the sensed electrical characteristic to a threshold value or range for the electrical characteristic, and determine if the sensed electrical characteristic satisfies the threshold value or range. If the electrical characteristic satisfies the threshold, the controller module 26 can generate a trigger signal by way of the trigger signal pathway 32, to the circuit breaker 14. The term “satisfies” the threshold value or range is used herein to mean that the sensed electrical characteristic satisfies the threshold, such as being equal to or less than the threshold value, or being within the threshold value range. It will be understood that such a determination may easily be altered to be satisfied by a positive or negative comparison or a true or false comparison.

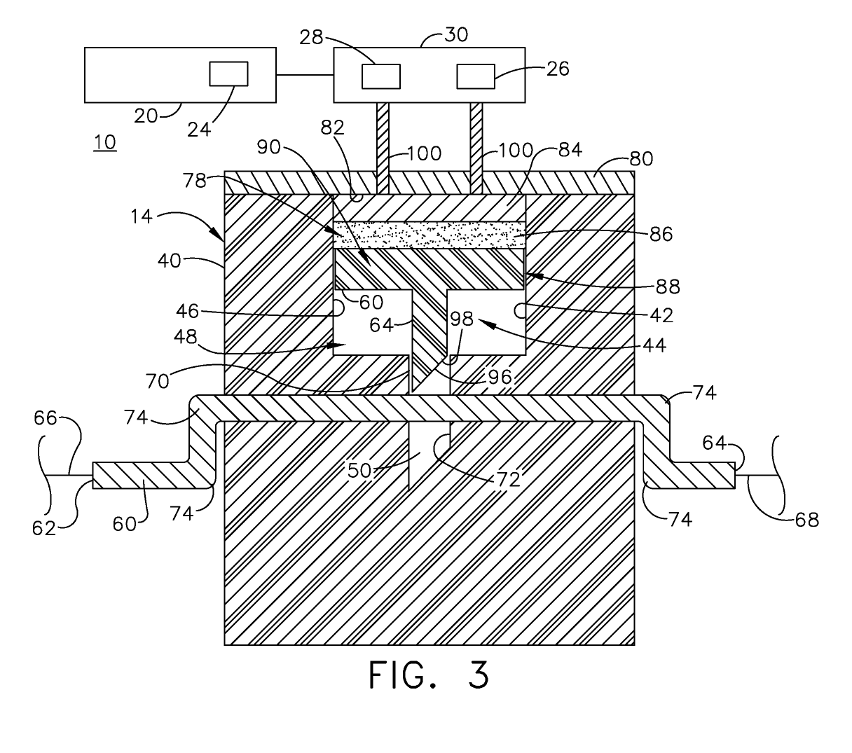

Referring now to FIG. 3, the electrical circuit 10 can include the circuit breaker 14 operatively coupled to the controller module 26. The circuit breaker 14 includes a housing 40 including an inner surface 42 defining a cavity 44, which can be a fluidly sealed volume expansion chamber. Alternatively, it is contemplated that the cavity 44 is not fluidly sealed. A side wall 46 can at least partially form the inner surface 42, and can include a cylindrical geometry, in one example, while any geometry is contemplated. The cavity 44 can be separated into a first portion 48 and a second portion 50, with the second portion 50 having a smaller cross-sectional area than the first portion 48.

An electrically conductive conductor 60, such as a conductive wire or a copper bar, extends through the housing 40 and the second portion 50 of the cavity 44. The electrically conductive conductor 60 extends between a first end 62 and a second end 64 electrically coupling an input 66 (e.g. such as the voltage source 12) and an output 68 (such as the electrical load 16), respectively, and can form at least a portion of the circuit 10. In one example, the conductor 60 can be soldered to the other conductors within the circuit 10. In another example, the conductor 60 can be a power distribution bus. The conductor 60 can at least partially separate the second portion 50 of the cavity 44 into an upper portion 70 and a lower portion 72. As shown, non-limiting aspects of the conductor 60 further can include four bends or elbows 74, such as having two elbows 74 adjacent each end 62, 64. The elbows 74 provide for raising the conductor 60 above a surface upon which the circuit breaker 14 is mounted. Non-limiting aspects of the disclosure can be included wherein the conductor 60 is formed without or with fewer elbows 74. The conductor 60 can be made of any suitable conductive material. Preferably, the conductor 60 is made of a highly conductive material that is readily severable.

A cap 80 can be provided on the housing 40 and can fluidly seal the cavity 44. The cap 80 can form a top wall 82 of the cavity 44, while it is contemplated that the housing 40 includes the top wall 82. The cap 80 can removably coupled to the housing 40, configured to separate from the housing 40 at a predetermined pressure of the cavity 44.

The cavity 44 can hold, contain, house, or the like, a plate 84, a piston 78 shown as a volume expansion composition 86, and a piston 88. The plate 84 can position adjacent to the cap 80 spanning the cavity 44 between the inner surface 42. The plate 84 can be made of an electrically conductive material, whereby the conduction of current through the plate 54, for instance, from the controller module 26, generates ohmic heating in the plate 54. A pair of leads 100 extend through the cap 80 to couple the plate 54 to the rest of the circuit 10, such as to the controller module 26.

The volume expansion composition 86 can be positioned between the plate 84 and the piston 88. The volume expansion composition 86 can be an element, isotope, composition, or chemical compound, such as a thermal chemical compound, configured or adapted to expand in volume. In one example, the volume expansion composition 56 can be Bromine Intercalated Graphite flakes or graphene. Intercalated graphite, when heated up to 100 degrees Celsius, can produce unidirectional expansion of greater than 400%. Such heating can include passing electricity through the intercalated graphite. In one additional example, the volume expansion composition 56 can be RDX as (O₂NNCH₂)₃ or C₃H₆N₆O₆, or other Nitramides, configured to produce combustion gases to increase volume, while any suitable explosive is contemplated. Non-limiting aspects of the disclosure can be included wherein the volume expansion composition 56 does not occupy all space between the piston 88 and the plate 84. In non-limiting examples, the volume expansion composition 86 can be a liquid, adapted to change phase to a gas as a result of heat generated by the plate 84, resulting in an increase in volume of the volume expansion composition 86. Alternatively, it is contemplated that the volume expansion composition 86 can be any phase, adapted to rapidly increase in volume due to the addition of heat to the volume expansion composition 86.

It is further contemplated that the volume expansion composition can be an actuator configured to operably drive the piston 88. Non-limiting examples can include motor driven actuator, a pressure driven actuator such as a hydraulic fluid or pneumatic pressure actuator, an electric actuator electrically coupled to the circuit 10, a thermal actuator, a magnetic actuator, or any other suitable mechanical actuator operable within the cavity 44. In one example, the actuator can have a head abutting the piston 88, with an arm configured to drive the piston 88. Such an actuator can be operable to extend along the cavity 44. In one example, such an actuator can be operable by the controller 26, or the controller via the plate 84 as described herein.

The piston 88 includes a cylindrical body 90 having a top portion 92 and a bottom portion 94. The top portion 92 can be contoured to match at least a portion of the inner surface 42 of the cavity 44, such as the first portion 48 of the cavity 44. Similarly, the bottom portion 94 of the body 90 can be contoured to match the inner surface 42 of the second portion 50 of the cavity 44. A blade end 96, or a cutter, can be formed in the bottom portion 94, opposite of and distal from the top portion 92, having a shearing blade 98. The blade end 96 can extend partially into the second portion 50 of the cavity 44, with the shearing blade 98 positioned within the second portion 50, such as proximate to the conductor 60, or opposite of the lower portion 72 relative to the conductor 60. The shearing blade 98 can be any edge suitable for cutting, severing, shearing, or otherwise mechanically breaking or decoupling a portion of the conductor 60 from the remaining conductor 60. In one non-limiting example, the shearing blade 98 can include a diagonal edge forming a blade. The piston 88 can be made of a non-conductive material or composition, such as a ceramic material in one non-limiting example, and can have a cylindrical shape, complementary to the cavity 44.

As shown, the piston 88 is provided in a first position, which can be a non-triggered position, with the piston 88 positioned above the conductor 60. The piston 88 can be maintained in the first position, either having the body 90 coupled to the volume expansion composition 86, or the bottom portion 94 resting upon the conductor 60, while any suitable method to retain the piston 88 in the first position is contemplated.

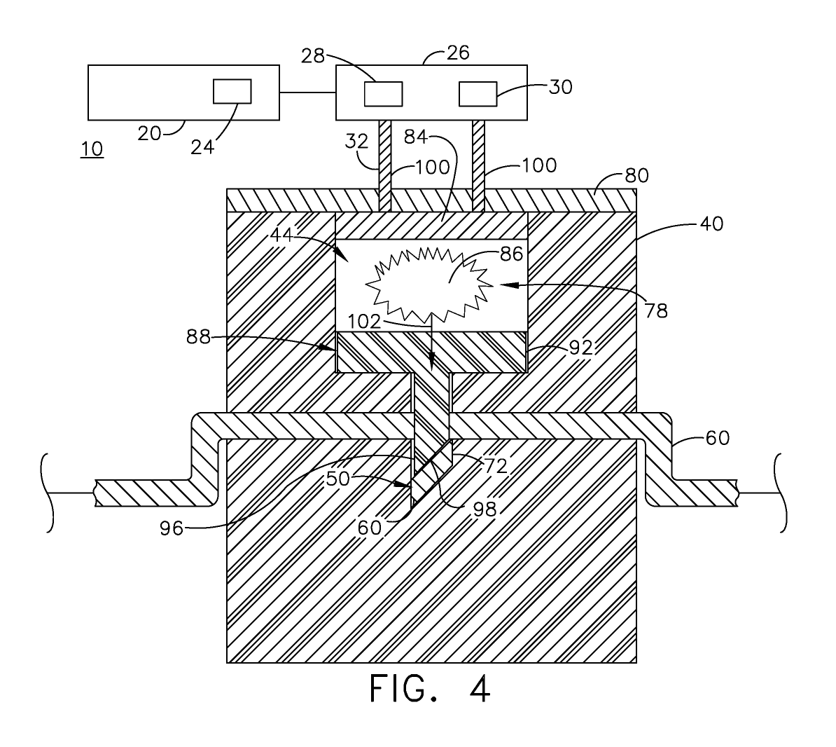

Referring now to FIG. 4, during a failure event of the circuit 10, such as an overload or short circuit, the piston 88 can be driven to a second position or a triggered position, as a result of a volume expansion of the volume expansion composition 86. In this example, the controller module 26, can provide an electrical signal or electrical current to the circuit breaker 14 at the leads 100. The controller 26 can be configured to receive a sensed electrical characteristic from the electrical characteristic sensor 24. The electrical characteristic, for example, can be a voltage value or range, a current value or range, or a power value or range, at the SSPC 20. The controller 26 can further compare the sensed electrical characteristic to a threshold value or range for the electrical characteristic, and determine if the sensed electrical characteristic satisfies the threshold value or range. If the electrical characteristic satisfies the threshold, the controller 26 can generate a trigger signal by way of the trigger signal pathway 32, to the leads 100 of the circuit breaker 14.

The leads 100 provide the electrical signal or current to the plate 84, resulting in heating of the plate 84. The plate 84 can be a trigger mechanism, for example, configured to trigger a volumetric expansion of the volume expansion composition 86, resultant of the trigger signal sent from the controller module 26. The heated plate 84 can resultantly trigger a volumetric expansion reaction in the volume expansion composition 86 resulting in rapid expansion of the volume and pressure within the cavity 44. It should be understood that the trigger mechanism as described herein provides for initiating volumetric expansion of the volumetric expansion composition 86, but does not initiate actuation of the shearing blade 98. Such initiation can be in the form of receiving an electrical signal from the controller 26, receiving an electrical current to heat the trigger mechanism, or any other suitable input to the trigger mechanism to initial expansion of the volume expansion composition 86. For instance, when the trigger mechanism is the plate 84 and the “trigger” is the generation of heat due to ohmic heating, the volume expansion composition 86 can include a thermally-triggered composition or include a thermally-triggered volumetric expansion. Additional or alternative suitable means for expanding volume of the volume expansion composition 86 within the cavity 44 is contemplated.

The volume expansion of the volume expansion composition 86, the increase in pressure, or a combination thereof, is received by the top portion 92 of the body 90 of the piston 88, and enables, effects, or operably drives the piston 88 downward through the cavity 44, as illustrated by arrow 102. The driving movement 102 of the piston 88 along the inner surface 42 or the side wall 46, or a similar movement 102 of the blade end 96 along the second portion 50 of the conduit, in turn, contacts the conductor 60. The contacting of the conductor 60 by the blade end 96 or the shearing blade 98 cuts, shears, disconnects, or otherwise breaks the electrical conduction between the input 66 and output 68. In one non-limiting aspect, at least a portion of the conductor 60 can be driven into the lower portion 72 of the cavity 44. Furthermore, the piston 88, being made of a non-conductive material, provides for electrically sealing the conductor 60, and thus effectively inserting a non-conductive material through the circuit 10 to break the circuit 10, while simultaneously physically separating the a conductive material of the conductor 60. Therefore, it should be appreciated that the piston 88 is linearly movable from the first position, or the non-triggered position, shown in FIG. 3 to the second position, or the triggered position, in FIG. 4 along the cavity 44 to sever the conductor 60, actuable by volumetric expansion of the volume expansion composition 86. Movement from the first position of FIG. 3 to the second position of FIG. 4 can be normal to or orthogonal to the conductor 60, while any suitable arrangement is contemplated.

Due to the increase in pressure within the cavity 44 resultant of the volume expansion of the volume expansion composition 86, the cap 80 can be separable from the housing 40 with the plate 84 at a predetermined pressure. Such separation can provide for a pressure release within the cavity 44, reducing the potential to damage to the circuit 10 resultant of the rapid volume expansion of the volume expansion composition 86.

While described as triggering a reaction of the volume expansion composition 56 is triggered by heat, it is also contemplated that electrical conduction or any other suitable trigger can initiate volume expansion of the volume expansion composition 56. In another non-limiting example, the plate 84, in response to the trigger signal, can trigger the expansion of the volume expansion composition 86. In another non-limiting example, in addition to the controller module 26 triggering the expansion of the volume expansion composition 86, the controller module 26 can operate the SSPC 20 or switchable element 22 to disconnect the downstream components of the electrical circuit 10 from the power source 12.

The electric circuit 10 can provide for a circuit breaker 14 that can operate to break the circuit 10 within 0.1 seconds or less. The ability to use the controller 26 to initiate the circuit breaker 14 based upon measurements of the SSPC 20 improves the speed of the circuit breaker 14 and can resolve failure issues in power devices. Furthermore, the mechanical circuit breaker 14 reduces, eliminates, or extinguishes an arcing effect, which is required for operation of typical melting-type fuses and electro-magnetic circuit breakers. Removal of the arcing effect reduces overall time to break the circuit, as well as eliminates the negative effects of arcing of the circuit.

Additionally, the ability to physically break the circuit 10, as described herein, is reliable over time, and does not degrade due to usage or passage of time. Furthermore, the circuit breaker 14 can have a compact design, saving space in particularly complex circuits or in industries requiring decreased spacing or weight. Further still, the circuit breaker 14 can be broad to any circuit implementation, over a wide range of AC or DC currents, as well as those above, at, or below 50 Amperes.

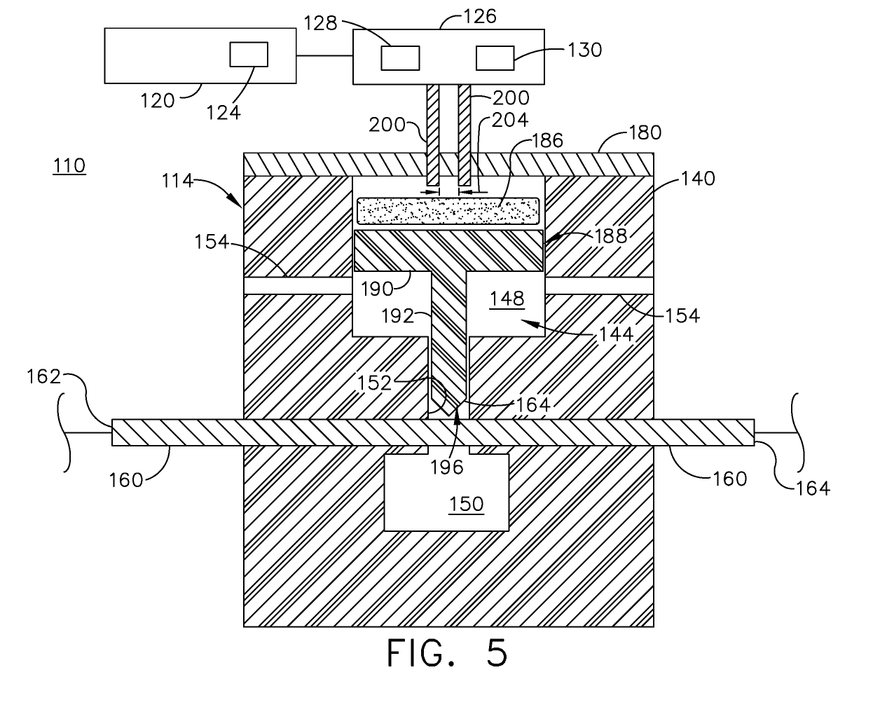

Referring now to FIG. 5, another portion of a circuit 110 including a circuit breaker 114 according to another aspect of the present disclosure is shown. The circuit breaker 114 is similar to the circuit breaker 14; therefore, like parts will be identified with like numerals increased by one hundred, with it being understood that the description of the like parts of the circuit breaker 14 applies to the circuit breaker 114, unless otherwise noted. One difference is that the cavity 144 can be separated into a first portion 148 and a second portion 150, interconnected by a conduit 152. The conductor 160 can pass through the housing 140 and through the conduit 152.

A set of pressure release conduits 154 extend from the first portion 148 of the cavity 144, through the housing 140, to external of the housing 140. The pressure release conduits 154 prevent the build-up of pressure within the cavity 144. The pressure release conduits 154 can be positioned below the body 190 of the piston 188, preventing a build-up of pressure below the body 190 and facilitating a linear sliding motion of the piston 188 along the cavity 144, which may otherwise be resisted by increasing pressure within the conduit 152 and the second portion 150 of the cavity 144 during movement of the piston 188.

The set of leads 200 extend through the cap 80, and are spaced from one another by a spark gap 204, positioning the spark gap 204 within the cavity 144. The set of leads 200, can also be spaced from the volume expansion composition 186. The piston 188 includes a blade end 196 terminating at a conic-shaped shearing blade 198, while the shearing blade 198 need not be diagonal or conic as described herein, but can be any suitable shape for severing, separating, or otherwise breaking the conductor 160. While the leads 200 are shown spaced from the volume expansion composition 186, non-limiting aspects of the disclosure can be included wherein the leads 200 are in electrical contact with the volume expansion composition 186.

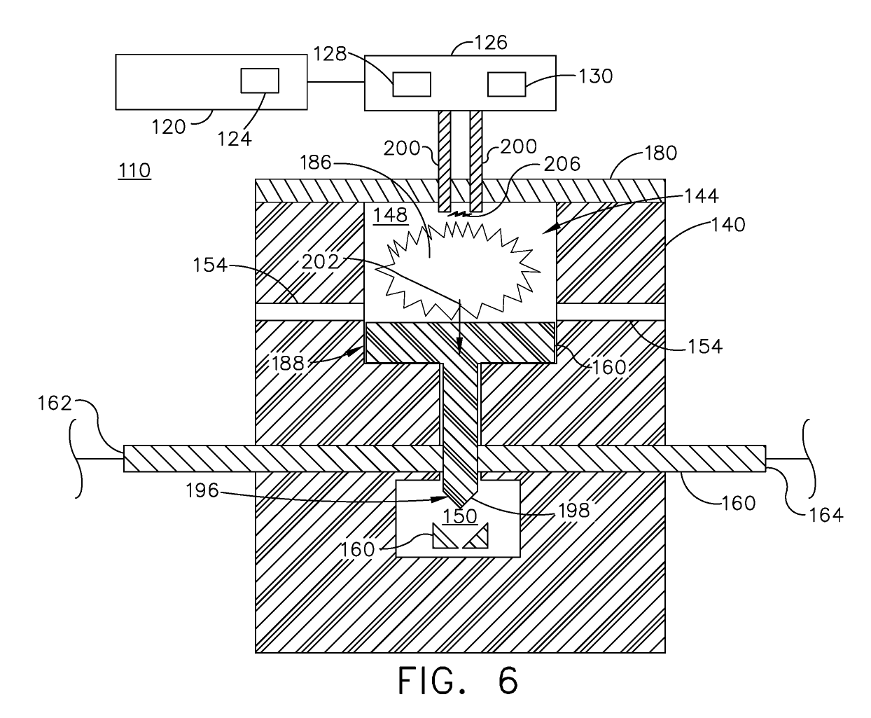

Referring now to FIG. 6, the piston 188 has been actuated to a second position, or a triggered position. Electricity or an electrical current can be provided to the set of leads 200 suitable to generate a spark 206 in the spark gap 204 to operably ignite the volume expansion composition 186, such as providing electricity to the leads 200 from a controller module 126. In another non-limiting example, wherein the leads 200 are in electrical contact with the volume expansion composition 186, the leads can directly trigger a spark 206 in the volume expansion composition 186, or directly ignite the volume expansion composition 186. The ignition of the volume expansion composition 186, causing an explosive thermal chemical reaction, causing local volume expansion with in the first portion 148 of the cavity 144 above the piston 188. The volume expansion of the reaction with the volume expansion composition 186 drives the piston 188 downward, as shown by arrow 202, moving the piston 188 into the second position. The blade end 196 or cutter cuts through the conductor 160, and pushes cut portions of the conductor 160 into the second portion 150 of the cavity 144. The second portion 150 facilitates linear motion of the blade end 196 through the conduit 160. The blade end 164, or non-conductive cutter, is positioned between the severed ends of the conductor 160 to prevent current passing along the conductor 160, even after severance.

The pressure release conduits 154 can be arranged to be positioned above the body 190 of the piston 188 when the piston 188 is in the second position, providing for the release of the pressure from the cavity 144 after volume expansion of the volume expansion composition 186 has occurred. The pressure release conduits 154 serve to facilitate maintenance of the circuit breaker 114 after use, as well as reduce the occurrence of damage to the circuit 110, the circuit breaker 114, or nearby components during operation of the circuit breaker 114. Pressure release from the cavity 144 also reduces the opportunity for cracking or fracturing of the housing 140.

After usage or operation of the circuit breaker 114, the cap 180 can be removed and the piston 188 and the volume expansion composition 186 can be replaced, providing for multiple uses. Additionally, a new conductor 160 can be provided through the circuit breaker 114, providing for additional uses of the circuit breaker 114.

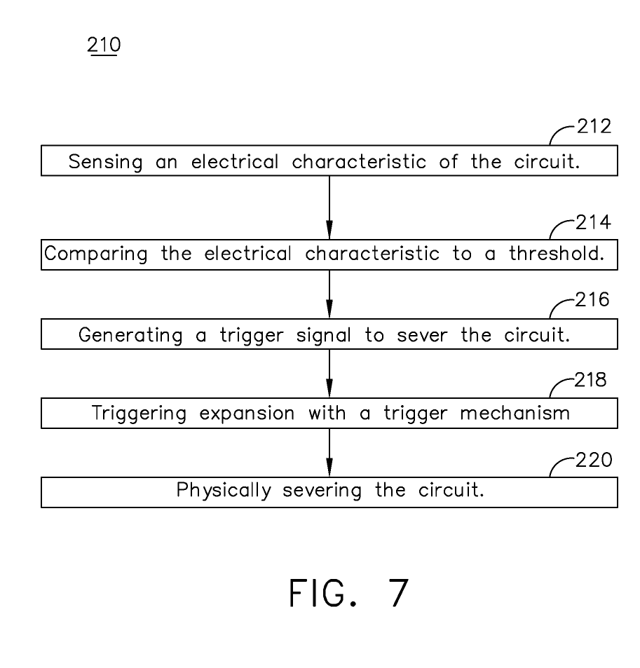

Referring now to FIG. 7, a method 210 of breaking a circuit 10, 110 utilizing the circuit breaker 14, 114 as described herein can include: at 212, sensing an electrical characteristic of the circuit 10, 110; at 214, comparing the electrical characteristic to a threshold; at 216, generating a trigger signal to sever the circuit when the threshold is met; at 218, triggering expansion with a plate 84; and, at 220, physically severing the circuit 10, 110.

At 212, sensing the electrical characteristic of the circuit 10, 110 with a controller module 26, 126 can include sensing an electrical characteristic with the electrical characteristic sensor 24 at the SSPC 20, and communicating that electrical characteristic to the controller 26, 126. The sensing can include sensing of at least one of a voltage or a current. At 214, the controller 26, 126 can compare a value of the sensed electrical characteristic with a threshold characteristic to determine if the sensed electrical characteristic satisfies the threshold value for the threshold characteristic.

At 216, the controller 26, 126 can generate a trigger signal when the sensed electrical characteristic satisfies the threshold characteristic. At 218, the method 210 can optionally include triggering expansion of a volume expansion composition 86, 186 with a trigger mechanism, such as the plate 84.

At 220, the circuit 10, 110 can be physically severed with a conductor severing assembly or circuit breaker 14, 114 including a blade 98, 198 or cutter, which can be actuated by a volume expansion composition 86, 186 within the circuit breaker 14, 114. The trigger signal triggers expansion of the volumetric expansion composition 86, 186 to drive the piston 88, 188, the shearing blade 98, 198, or the like through the conductor 60, 160 to sever the conductor 60, 160 passing through the housing 40, 140. The trigger signal, for example, can be sent to the leads 100, 200 of FIG. 3 to heat the plate 84 to trigger expansion of the volume expansion composition 86, 186. The trigger mechanism as the plate, for example, can generate heat or conduct electricity to initiate expansion of the volume expansion composition 86, 186. Therefore, a measurement by the controller that satisfies the threshold characteristic can be used to operably enable the physical breaking of the circuit 10, as described herein.

The circuit breaker and electrical circuits as described herein provide for faster breaking of a circuit in a failure mode based upon a logical analysis of a SSPC working condition, or other suitable logical analysis. The technical effect is that the above described aspects enable severing, cutting, disconnecting, or otherwise disabling of an electric conduction or conducting wire, in response to a failure mode determination. Other suitable logical analyses could include a gate input signal, an output current, or otherwise. Additionally, the circuit breaker eliminates the arc effect for common melting type fuses and electromagnetic type circuit breakers. Eliminating the arc effect can significantly decrease operational time of the circuit breaker, as well as eliminating the potential detriment to the circuit due to an arc. Furthermore, the circuit breaker can be of a compact and small size, while remaining inexpensive as compared to some circuit breakers. The circuit breaker as described herein can be suitable for different or all types of power supplies, powered electronics or circuit boards, or any suitable electrical power distribution system.

To the extent not already described, the different features and structures of the various embodiments can be used in combination with each other as desired. That one feature is not illustrated in all of the embodiments is not meant to be construed that it cannot be, but is done for brevity of description. Thus, the various features of the different embodiments can be mixed and matched as desired to form new embodiments, whether or not the new embodiments are expressly described. All combinations or permutations of features described herein are covered by this disclosure.

This written description uses examples to disclose the invention, including the best mode, and to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A conductor severing assembly, comprising:
a housing having an inner surface defining a cavity;
a conductor extending through the housing;
a piston disposed within the cavity contoured to match at least a portion of the inner surface and linearly moveable between a first position and a second position; and
an actuator disposed within the cavity;
whereby the actuator operably drives the piston from the first position to the second position, wherein the second position severs the conductor.

2. The conductor severing assembly of claim 1 wherein the piston is ceramic.

3. The conductor severing assembly of claim 1 wherein the piston further includes a blade end including a shearing blade configured to sever the conductor.

4. The conductor severing assembly of claim 1 wherein the cavity is cylindrical and at least a portion of the piston includes a cylindrical body complementary to the cavity.

5. The conductor severing assembly of claim 1 wherein the piston is linearly movable from the first position to the second position in a direction that is normal to the conductor.

6. The conductor severing assembly of claim 1 wherein the actuator is a volume expansion composition.

7. The conductor severing assembly of claim 6 wherein the volume expansion composition is triggered by heat.

8. The conductor severing assembly of claim 7, further comprising a trigger mechanism positioned proximate to the volume expansion composition, and configured to generate heat to trigger expansion of the volume expansion composition.

9. The conductor severing assembly of claim 6 wherein the volume expansion composition is triggered by at least one of a current or a spark.

10. The conductor severing assembly of claim 6 wherein the volume expansion composition is Bromine Intercalated Graphite or RDX.

11. A circuit breaker device, comprising:
a housing defining a volume expansion chamber, the volume expansion chamber defined by at least one side wall and a top wall;
a conductor extending through the housing and electrically connecting an input with an output and at least partially defining a circuit;
a cutter disposed within the housing and having a first blade end and an opposing second end, the second end contoured to corresponding with the at least one side wall of the volume expansion chamber;
a volume expansion composition disposed within the volume expansion chamber between the top wall and the second end of the cutter, the volume expansion composition configured to volumetrically expand in response to a trigger signal; and
a controller module configured to sense an electrical characteristic of the circuit, and in response to determining the electrical characteristic of the circuit satisfies a threshold electrical characteristic, generating the trigger signal;
whereby the volumetric expansion of the volume expansion composition within the volume expansion chamber against the second end of the cutter operably forces the first blade end of the cutter through the conductor such that the first blade end electrically disconnects the input from the output.

12. The circuit breaker device of claim 11, further comprising an electrical characteristic sensor.

13. The circuit breaker device of claim 12 wherein the controller module is communicably coupled to the electrical characteristic sensor and configured to receive a sensed electrical characteristic of the conductor.

14. The circuit breaker device of claim 11 wherein the circuit breaker device is is a circuit board assembly component.

15. The circuit breaker device of claim 11 wherein the conductor is a power distribution bus.

16. The circuit breaker device of claim 11 wherein the first blade end is configured to bisect the conductor.

17. A method of breaking a circuit comprising:
sensing, by a sensor, an electrical characteristic of the circuit;
comparing, by a controller module, the sensed electrical characteristic with a threshold characteristic;
generating, by the controller module a trigger signal when the sensed electrical characteristic satisfies the threshold characteristic; and
physically severing a conductor of the circuit with a conductor severing assembly including a cutter actuable by a volume expansion composition;
wherein the trigger signal triggers expansion of the volumetric expansion composition to actuate the cutter.

18. The method of claim 17 wherein the sensing includes sensing at least one of a voltage or a current.

19. The method of claim 17 further comprising triggering the volume expansion composition with a trigger mechanism.

20. The method of claim 17 wherein the physically severing is completed in less than 0.1 seconds.
